(19) United States
(12) Patent Application Publication
(10) Pub. No.: US 2016/0207535 A1
(43) Pub. Date: Jul. 21, 2016

(54) AUTOMATICALLY ADAPTABLE SPEED CRUISE CONTROL DEVICE

(71) Applicants: Netty Bwalanda, Franklin, IN (US); Percy Bwalanda, Franklin, IN (US)

(72) Inventors: Netty Bwalanda, Franklin, IN (US); Percy Bwalanda, Franklin, IN (US)

(21) Appl. No.: 14/601,972

(22) Filed: Jan. 21, 2015

(51) Int. Cl. B60W 30/14; G01S 19/13

(52) U.S. Cl. CPC B60W 30/143; G01S 19/13

(57) ABSTRACT

An automatically adaptable speed cruise control device utilizes global positioning system data linked to a cruise control unit to adjust vehicle speed automatically while traveling. The device includes a vehicle and a cruise control unit operationally coupled to the vehicle such that the vehicle is maintained at a cruising speed by the cruise control unit. A global positioning system unit is coupled to the vehicle. The global positioning system unit is operationally linked to the cruise control unit wherein the cruising speed of the vehicle is changeable corresponding to speed limit data associated with a position of the vehicle as determined by the global positioning system unit.

### BACKGROUND OF THE DISCLOSURE

1. Field of the Disclosure

The disclosure relates to cruise control devices and more particularly pertains to a new cruise control device for utilizing global positioning system data linked to a cruise control unit to adjust vehicle speed automatically while traveling.

### SUMMARY OF THE DISCLOSURE

An embodiment of the disclosure meets the needs presented above by generally comprising a vehicle and a cruise control unit operationally coupled to the vehicle such that the vehicle is maintained at a cruising speed by the cruise control unit. A global positioning system unit is coupled to the vehicle. The global positioning system unit is operationally linked to the cruise control unit wherein the cruising speed of the vehicle is changeable corresponding to speed limit data associated with a position of the vehicle as determined by the global positioning system unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of an automatically adaptable speed cruise control device according to an embodiment of the disclosure.

FIG. 2 is a schematic view of an embodiment of the disclosure.

FIG. 3 is an alternative schematic view of an embodiment of the disclosure.

### DESCRIPTION OF THE PREFERRED EMBODIMENT

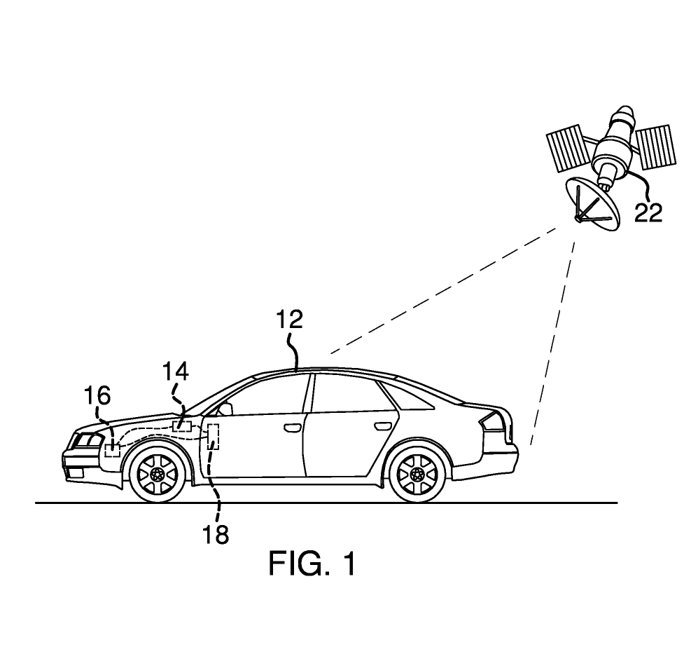

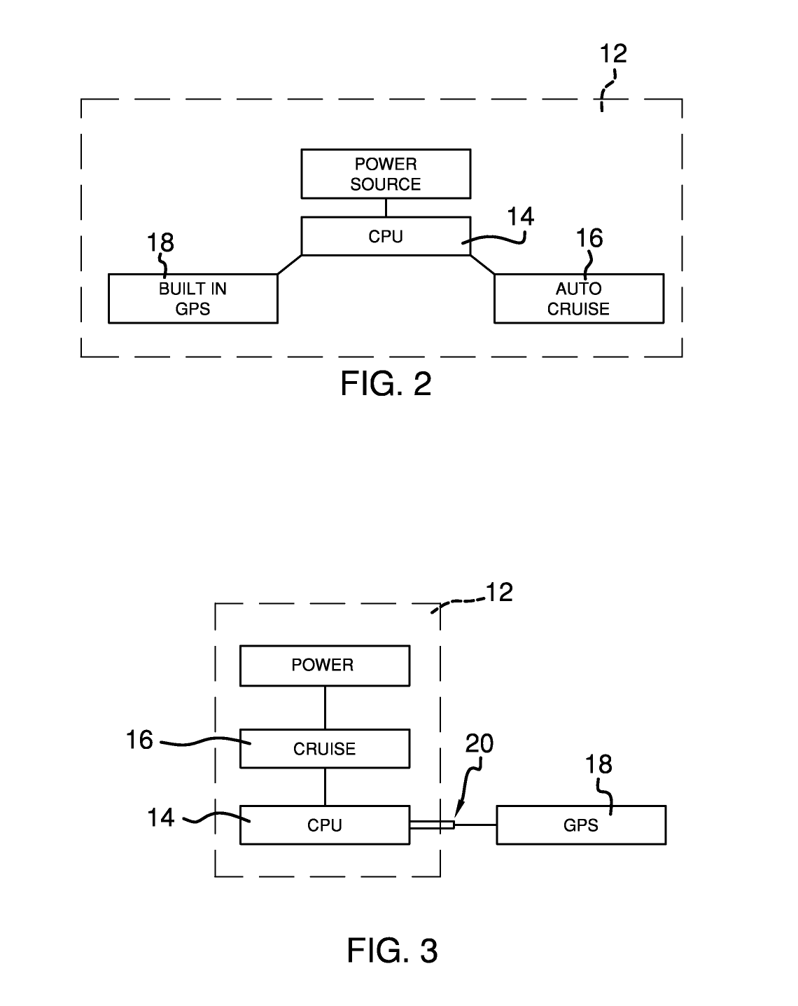

With reference now to the drawings, and in particular to FIGS. 1 through 3 thereof, a new cruise control device embodying the principles and concepts of an embodiment of the disclosure and generally designated by the reference numeral 10 will be described.

As best illustrated in FIGS. 1 through 3, the automatically adaptable speed cruise control device 10 generally comprises a vehicle 12 and a processor 14 coupled to the vehicle 12. A cruise control unit 16 is operationally coupled to the vehicle 12 such that the vehicle 12 is maintained at a cruising speed by the cruise control unit 16 in a conventional manner controlling a throttle and brake of the vehicle 12. The cruise control unit 16 may be original equipment manufacture for the vehicle 12 and is operationally coupled to the processor 14 such that operation of the cruise control unit 16 for setting a cruising speed is controllable by the processor 14. A global positioning system unit 18 is provided either through original equipment manufacture for the vehicle 12 or as an aftermarket addition. The global positioning system unit 18 is coupled to the vehicle 12 to utilizes global positioning satellites 22 as needed. The global positioning system unit 18 is operationally coupled to the processor 14 wherein the global positioning system unit 18 provides speed limit data associated with a position of the vehicle 12 to the processor 14. Thus, the cruising speed is adaptable by operation of the processor 14 to correspond to the speed limit data.

A port 20 may be provided in the vehicle 12 or on a housing for the processor 14. The port 20 is coupled to the vehicle 12 and communicatively coupled to the processor 14. The global positioning system unit 18 is coupled to the processor 14 by connection to the port 20.

In use, the processor 14 is communicatively coupled to and functionally integrated with the cruise control unit 16 and the global positioning system unit 18. When activated, the processor 14 utilizes global positioning data including speed limit data to automatically adjust the cruising speed of the vehicle 12 as maintained by the cruise control unit 16 according to the speed limit for the position of the vehicle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. An automatically adaptable speed cruise control device comprising:
a vehicle;
a processor coupled to said vehicle;
a cruise control unit operationally coupled to said vehicle such that said vehicle is maintained at a cruising speed by said cruise control unit, said cruise control unit being operationally coupled to said processor such that operation of said cruise control unit is controllable by said processor;
a global positioning system unit coupled to said vehicle, said global positioning system unit being operationally coupled to said processor wherein said global positioning system unit provides speed limit data associated with a position of said vehicle to said processor wherein said cruising speed is adaptable by operation of said processor to correspond to said speed limit data, said global positioning system unit being an aftermarket addition with respect to said vehicle; and
a port coupled to said vehicle, said port being communicatively coupled to said processor, said global positioning system unit being coupled to said processor by connection to said port.

3. (canceled)

4. The device of claim 2, further comprising said cruise control unit being original equipment manufacture for said vehicle.

5. (canceled)

6. (canceled)

7. (canceled)

8. (canceled)
